(19) United States
(12) Patent Application Publication
(10) Pub. No.: US 2010/0062797 A1
(43) Pub. Date: Mar. 11, 2010

(54) METHOD FOR GROUP COMMUNICATION BETWEEN SUBSCRIBERS TO DIFFERENT MESSAGING SERVICES, COMMUNICATION TERMINAL AND COMPUTER PROGRAM PRODUCT

(75) Inventors: Frank Kowalewski, Unterhaching (DE); Thomas Luetzenkirchen, Taufkirchen (DE)

Correspondence Address: Viering, Jentschura & Partner, 3770 Highland Ave., Suite 203, Manhattan Beach, CA, 90266, US

(73) Assignee: INFINEON TECHNOLOGIES AG, Neubiberg (DE)

(21) Appl. No.: 12/557,563

(22) Filed: Sep. 11, 2009

(30) Foreign Application Priority Data
Sep. 11, 2008 (DE) 102008046713.8

(51) Int. Cl. H04W 4/12

(52) U.S. Cl. 455/466

(57) ABSTRACT

A method for group communication between subscribers to different messaging services involves a first message, which has been sent by a second subscriber using a first messaging service, being received by a communication terminal of a first subscriber in a group communication session in which said communication terminal, the second subscriber and a third subscriber are participating. The communication terminal is used in the group communication session to send a second message, which contains a content from the received first message, to the third subscriber for reception using a second messaging service, which is different than the first messaging service.

### CROSS-REFERENCE TO RELATED APPLICATION

This application claims priority to German Patent Application Serial No. 10 2008 046 713.8, which was filed Sep. 11, 2008, and is incorporated herein by reference in its entirety.

### TECHNICAL FIELD

Various embodiments relate to a method for group communication between subscribers to different messaging services, a communication terminal and a computer program product.

### BACKGROUND

Communication using technical means between a finite number of particular subscribers is referred to as a communication session. In a group communication session, also known by the terms “group session” and “chat room”, a message sent by a subscriber can be delivered to a plurality of or all other subscribers in the group communication session. Such messages are referred to as group messages. Group messages can be distributed to the various subscribers by a server, for example a messaging service server.

There are different messaging services whose message transfer protocols are incompatible. Compatibility is also frequently undesirable to the service providers. If two subscribers in a group communication wish to use different messaging services, there is the problem that a messaging service server for one service can neither send nor receive a message based on the other service.

### SUMMARY OF THE INVENTION

In various embodiments, a method for group communication between subscribers to different messaging services is provided. The method may include receiving a first message, which has been sent by a second subscriber using a first messaging service, by means of a communication terminal of a first subscriber, in a group communication session in which the communication terminal of the first subscriber, a second subscriber and a third subscriber are participating; and sending a second message, which contains a content from the received first message, by means of the communication terminal, in the group communication session, to the third subscriber for reception using a second messaging service, which is different than the first messaging service.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram of the system architecture of a messaging service in accordance with an exemplary embodiment;

FIG. 2 shows a message flowchart for a group communication session in accordance with an exemplary embodiment;

FIG. 3 shows a block diagram of the system architecture with two different messaging services in accordance with an exemplary embodiment;

FIG. 4 shows a message flowchart showing the message flow when a message is simultaneously sent to two different messaging services in accordance with an exemplary embodiment;

FIG. 5 shows a message flowchart showing the message flow when a response message is distributed, in accordance with an exemplary embodiment;

FIG. 6 shows a block diagram of a system architecture with a messaging service portal and two different messaging services in accordance with an exemplary embodiment;

FIG. 7 shows a message flowchart showing the message flow when a message is simultaneously sent using a messaging service portal in accordance with an exemplary embodiment; and

FIG. 8 shows a message flowchart showing the message flow when a response message is distributed using a messaging service portal in accordance with an exemplary embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. In this regard, directional terminology, such as “top”, “bottom”, “front”, “back”, “leading”, “trailing”, etc, is used with reference to the orientation of the Figure(s) being described. Because components of embodiments can be positioned in a number of different orientations, the directional terminology is used for purposes of illustration and is in no way limiting. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description therefore, is not to be taken in a limiting sense, and the scope of the present invention is defined by the appended claims.

The word “exemplary” is used herein to mean “serving as an example, instance, or illustration”. Any embodiment or design described herein as “exemplary” is not necessarily to be construed as preferred or advantageous over other embodiments or designs.

Within the context of this description, the terms “connected” and “coupled” are used to describe either a direct or an indirect connection and a direct or an indirect coupling.

FIG. 1 shows the basic system architecture of a messaging service.

Messaging services allow messages to be interchanged between communication partners. By way of example, text messages can be interchanged. A messaging service, that is to say the functions that a messaging service provides for the communication partners involved, is provided by a messaging service server. The subscribers to the messaging service do not communicate with one another directly in this case, but rather via the server.

In the example shown, a first subscriber (T1) 101, a second subscriber (T2) 102 and a third subscriber (T3) 103 are participating in a group communication session. In this case, the subscribers 101, 102, 103 interchange messages using the messaging service server (NS) 110.

A communication session is intended to be understood to mean communication using technical means between a finite number of particular subscribers. In this patent application, the term “subscriber” is intended to cover both the person participating in a communication and the technical means used by this person for communication. By way of example, the first subscriber 101 uses a communication terminal for communication. This may be a telephone, a mobile radio telephone or a computer, for example. The communication terminal is coupled to the messaging service server 110 by means of a suitable communication link, for example a mobile radio link or a wired connection. The second subscriber 102 and the third subscriber 103 likewise use technical devices, for example likewise communication terminals, to communicate with the messaging service server 110.

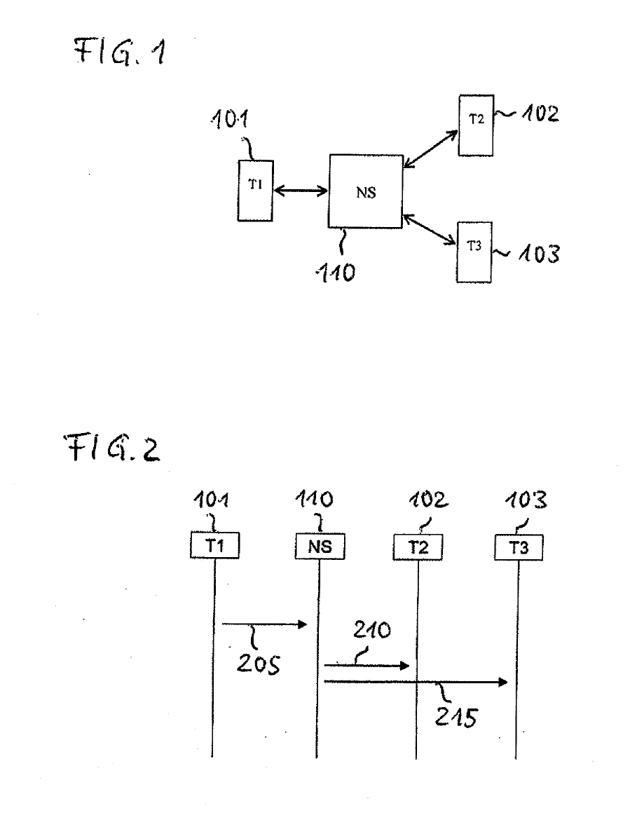

FIG. 2 shows a message flow in a group communication session between the subscribers 101, 102, 103 and the messaging service server 110.

Two or else more than two communication partners can interchange instant messaging messages, for example, with one another. This can be done in a group session or group communication session (chat room) for the relevant communication partner or subscriber. In this case, a message which is sent to a plurality of subscribers is distributed to all subscribers in the session apart from the sending subscriber by the relevant messaging service server. A corresponding message flow is shown in FIG. 2. By way of example, the first subscriber 101 wishes to send a group message to the second subscriber 102 and the third subscriber 103. For this, the first subscriber 101 sends the message 205 to the messaging service server 110. The latter forwards the message 205 (to be more precise, the content of the message 205) to the second subscriber 102 in the form of the message 210 and to the third subscriber 103 in the form of the message 215. Similarly, it is also possible to forward a message from a subscriber to a messaging server, from a subscriber to another subscriber or from a messaging server to another messaging server.

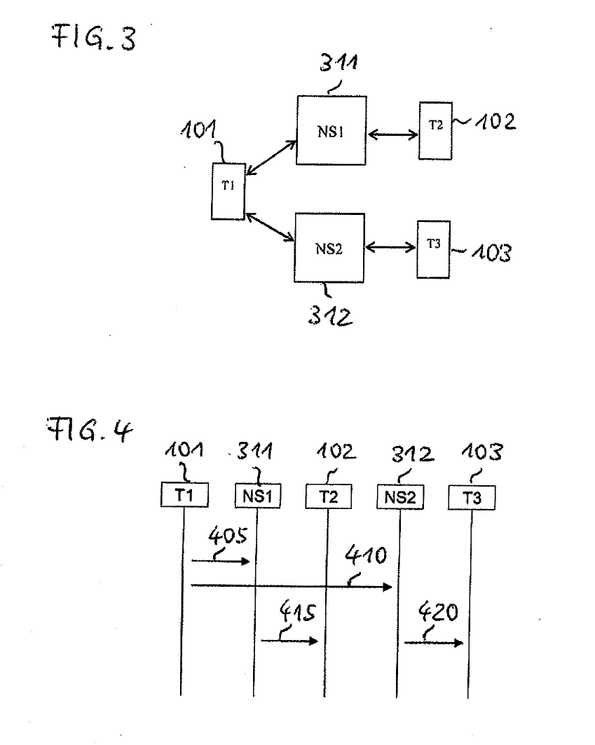

FIG. 3 shows a system architecture with two different messaging services.

A first messaging service server (NS1) 311 provides a first messaging service, and a second messaging service server (NS2) 312 provides a second messaging service. In this example, the first subscriber 101 or the communication terminal thereof is configured to communicate both using the first messaging service and using the second messaging service. The subscriber 101 can thus interchange messages with the messaging service server 311 and messages with the messaging service server 312. The second subscriber 102 is a subscriber to the first messaging service, and can interchange messages only with the messaging service server 311. The third subscriber 103 is a subscriber to the second messaging service, and can interchange messages only with the messaging service server 312.

It is now assumed that the first messaging service server 311 provides the messaging service AIM and the second messaging service server 312 provides the messaging service Yahoo Instant Messenger. The three subscribers 101, 102, 103 wish to perform group communication across messaging services using AIM and Yahoo. Subscriber 101 is a member of AIM and Yahoo, and wishes to interchange instant messages with subscriber 102 using AIM and with subscriber 103 using Yahoo in a group communication session. The communication terminal of the subscriber 101 provides an AIM application for communication using AIM and a Yahoo application for communication using Yahoo. In this case, an application is to be understood to mean a computer application which is executed by a processor in the communication terminal of the subscriber 101.

The subscriber 101 uses the AIM application to register with the AIM messaging service and uses the Yahoo application to register with the Yahoo messaging service. The subscriber 101 then calls an auxiliary application.

In this case, the term “auxiliary application” is just a name to distinguish it from the other applications described in this description. The auxiliary application can request information from the AIM application and the Yahoo application and control these two applications. The auxiliary application is a computer application which is executed by a processor in the communication terminal of the subscriber 101. By way of example, the auxiliary application may be implemented by means of what is known as Apple Script on an Apple Macintosh computer.

The auxiliary application then requests all the AIM and Yahoo messaging contacts (buddies) of the subscriber 101 from the AIM application and the Yahoo application and shows them to the user in a list. The user selects the subscribers 102 and 103 from this list and produces a new message with a message content (message body) and subject information and notifies the auxiliary application that he wishes to send the message in a group communication session.

FIG. 4 shows the message flow when the new message described in the previous section is sent as a group message.

The auxiliary application now controls the AIM application and the Yahoo application such that the AIM application produces a message 405 with the content and the subject of the message which is to be sent and the Yahoo application produces a message 410 with the content and the subject of the message which is to be sent. In this case, the message 405 is addressed to the second subscriber 102 and the message 410 is addressed to the third subscriber 103. The auxiliary application then has the two messages 405 and 410 sent by the AIM application and the Yahoo application. The message 405 is sent by the terminal of the subscriber 101 to the messaging service server 311, which is configured on the basis of AIM. The message 410 is sent by the communication terminal of the subscriber 101 to the messaging service server 312, which is configured on the basis of Yahoo. The AIM messaging service server forwards the message 405 to the second subscriber 102 in the form of the message 415. The Yahoo messaging service server forwards the message 410 to the third subscriber 103 in the form of the message 420.

FIG. 5 shows the message flow when the second subscriber 102 responds to the group message from the first subscriber 101, received in the form of the AIM message 415.

In order to respond to the received message, the second subscriber 102 uses the AIM application thereof to produce a response message 505 and sends it to the first subscriber 101. To be more precise, the second subscriber 102 addresses the message 505 to the first subscriber 101 and sends it to the AIM messaging service server, that is to say the first messaging service server 311. The message 505 is thus sent to the first subscriber 101 using the first messaging service server 311. This is an example of a first message which has been sent by the second subscriber using a first messaging service. In this case, the message 505 indicates in the subject of the message that it is a response to the received group message.

The message 505 is transmitted to the first subscriber 101 by the first messaging service server 311 as message 510, that is to say it is transmitted to the first subscriber 101 using the messaging service AIM. The first subscriber 101 receives the message 510 using said subscriber's AIM application. This is an example of a communication terminal of a first subscriber being used to receive, in a group communication session in which the communication terminal of the first subscriber, a second subscriber and a third subscriber are participating, a first message which has been sent by the second subscriber using a first messaging service.

The auxiliary application in the terminal of the subscriber 101 then checks the subject of the received message. From the subject, the auxiliary application recognizes that the received message is a response to the first message from the subscriber 101, sent in the group session. The auxiliary application then determines all subscribers in the group communication session apart from the sender, that is to say the subscriber 102, and the receiver, that is to say the subscriber 101, of the response message, and finds that the third subscriber 103 is another subscriber in the group communication session. In this case, it is recognized that the subscriber 103 is participating in the group communication session using the Yahoo messaging service.

The auxiliary application now produces a new Yahoo message 515 and copies the content and the subject of the received message 510 to the new Yahoo message 515. As sender specification, the auxiliary application inserts not the subscriber 101 but rather the subscriber 102 as the original sender of the message into the message 515 and sends the message, addressed to the subscriber 103, to the Yahoo messaging service server, that is to say the second messaging service server 312. The messaging service server 312 forwards the message 515 to the third subscriber 103 in the form of the message 520, and the third subscriber 103 receives the message 520 using the Yahoo messaging service. The sending of the message 515 by the first subscriber 101 is an example of the communication terminal being used to send, in the group communication session, a second message, which contains a content from the received first message, to the third subscriber for reception using a second messaging service, which is different than the first messaging service.

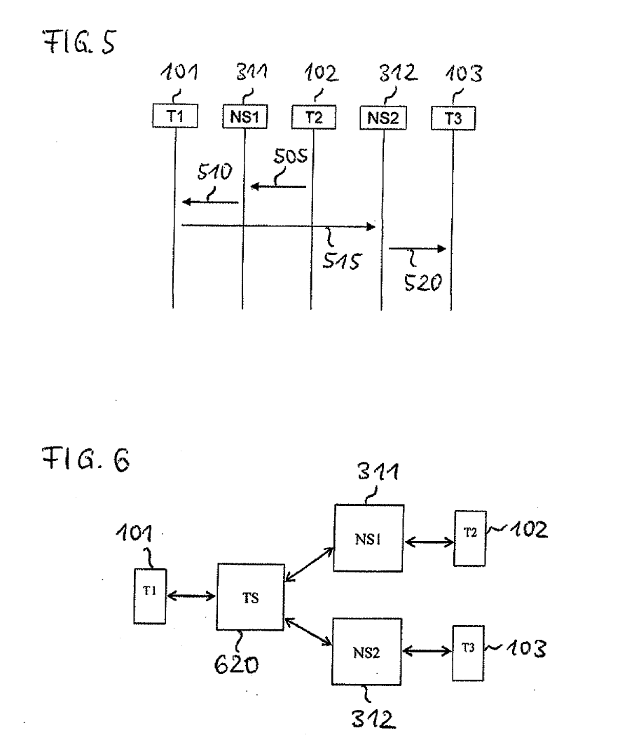

FIG. 6 shows a system architecture with two different messaging services and a messaging service portal.

The architecture in FIG. 6 is similar to the architecture shown in FIG. 3, but the first subscriber 101 in the architecture in FIG. 6 does not communicate with the first messaging service server 311 and the second messaging service server 312 directly, but rather using a messaging service portal, for example using the messaging service portal from the provider TJAT. This messaging service portal is implemented by what is known as a terminal server. The terminal server TS (620) is interposed both in the communication between the first subscriber 101 and the first messaging service server 311 and in the communication between the first subscriber 101 and the second messaging service server 312. It is also assumed, in a manner similar to the example illustrated with reference to FIG. 3, that the subscriber 102 uses AIM and the subscriber 103 uses Yahoo to participate in the group communication session.

The first subscriber 101 communicates with the terminal server 620 using a WAP browser. The terminal server 620 contains AIM and Yahoo applications in order to communicate with the AIM and Yahoo messaging service servers. In this example too, the subscriber 101 is a member of AIM and Yahoo. He wishes to interchange instant messages with the subscriber 102 using AIM and with the subscriber 103 using Yahoo in a group communication session.

To this end, the subscriber 101 starts an auxiliary application on his terminal and registers with the AIM messaging service and with the Yahoo messaging service in a WAP browser using the terminal server 620. The auxiliary application can request information from the WAP browser and can control said browser. The subscriber 101 then uses WAP to request his AIM and Yahoo messaging contacts from the terminal server 620. The terminal server 620 requests all the AIM and Yahoo messaging contacts of the subscriber 101 from the AIM and Yahoo servers, that is to say the first messaging service server 311 and the second messaging service server 312, and transmits them by WAP to the subscriber 101. The user selects the subscribers 102 and 103 from the transmitted contacts and uses his terminal to notify the terminal server 620 that he wishes to send a new message in a group communication session with the selected contacts.

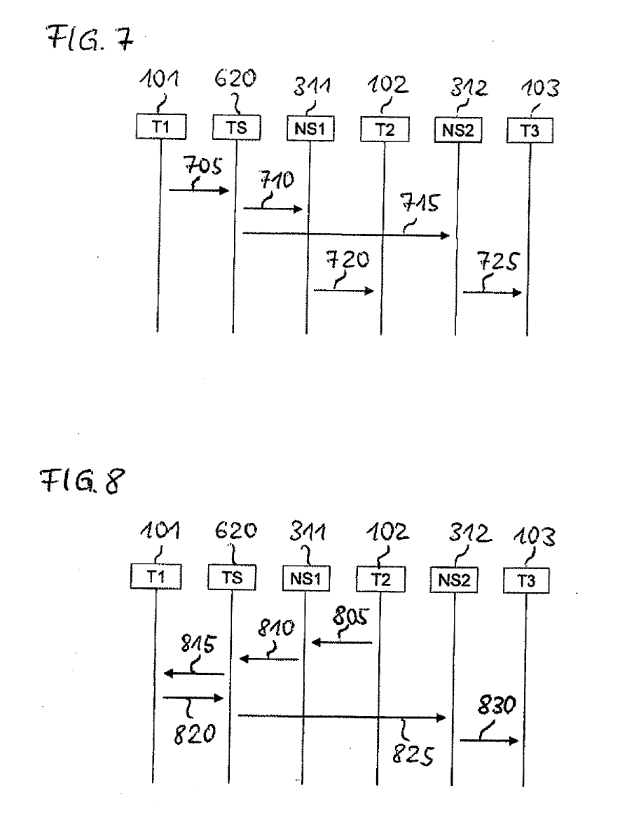

FIG. 7 shows the message flow when a new message is sent in the group communication session with the subscribers 101, 102 and 103 in the system architecture from FIG. 6.

The terminal server 620 provides the subscriber 101 with a form for transmitting message content and message subject by WAP. The subscriber 101 makes the entries in the WAP form and sends the entries made to the terminal server 620 in the message 705 by WAP for the purpose of forwarding.

The data received in message 705 are then used by the terminal server 620 to produce an AIM message 710 which it sends to the first messaging service server 311. The data received in message 705 are likewise taken by the terminal server 620 to produce a Yahoo message 715, which it sends to the second messaging service server 312. The AIM and Yahoo messaging service servers then forward the received messages 710 and 715 to the subscribers 102 and 103 in the form of the messages 720 and 725.

FIG. 8 shows the message flow when the second subscriber 102 wishes to respond to the group message from the first subscriber 101, received in the form of the AIM message 720 in line with the message flow shown in FIG. 7.

The subscriber 102 uses his AIM application to produce a response message 805, addresses it to the subscriber 101 and sends it. The response message indicates in the subject that it is the response to the received message. The response message 805 is sent to the terminal server 620 by means of the AIM messaging service server 311 using AIM message 810. The terminal server notifies the subscriber 101 of the received message by WAP using the message 815. This can be done using WAP Push (active sending using WAP) on the terminal server 620, for example, or by virtue of the WAP browser on the terminal of the subscriber 101 periodically requesting any new messages which may be present on the terminal server 620. The reception of the message 815 is an example of a communication terminal of a first subscriber being used to receive a first message, which has been sent by the second subscriber using a first messaging service, in a group communication session in which the communication terminal of the first subscriber, a second subscriber and a third subscriber are participating.

The auxiliary application in the communication terminal of the subscriber 101 now checks the subject of the received message 815. From the subject, the auxiliary application recognizes that the received message 815 is a response to the first message 705 from the subscriber 101, sent in the group communication session. The auxiliary application then determines all subscribers in the group communication session apart from the sender of the message, the subscriber 102, and the receiver of the response message, the subscriber 101, and finds that in addition the subscriber 103 is also participating in this group communication session as a subscriber to the Yahoo messaging service.

The auxiliary application then uses the WAP browser to produce a new message 820 and copies the content and the subject of the received message 815 into the new message 820. As sender specification, the auxiliary application inserts not the subscriber 101 but rather the subscriber 102, who is the original sender of the message, into the new message 820, addresses this message 820 to the third subscriber 103 and sends this message. The message 820 is routed via the terminal server 620 in the form of the Yahoo message 825 to the Yahoo messaging service server 312, and from the latter in the form of the Yahoo message 830 to the third subscriber 103. The third subscriber 103 therefore receives the message 820 from the subscriber 101 in the form of the Yahoo message 830. The sending of the message 820 by the first subscriber 101 is an example of the communication terminal being used, in the group communication session, to send a second message, which contains a content from the received first message, to the third subscriber for reception using a second messaging service, which is different than the first messaging service.

The communication terminal of the first subscriber 101, which receives the message 510 (see FIG. 5) or which receives the message 815, is an example of a communication terminal which has a reception device which is configured to receive a first message, which has been sent by the second subscriber using a first messaging service, in a group communication session in which the communication terminal, a second subscriber and a third subscriber are participating.

The communication terminal of the subscriber 101, which sends the message 515 (see FIG. 5) or which sends the message 820, is an example of a communication terminal which has a transmission device which is configured to send, in the group communication session, a second message, which contains a content from the received first message, to the third subscriber for reception using a second messaging service, which is different than the first messaging service.

Various embodiments allow group communication between subscribers to different messaging services.

In line with various exemplary embodiments of the invention, the content of a message received by means of a communication terminal is sent in automated fashion by means of the communication terminal to subscribers to other messaging services. The message is sent to selected members of a subscriber group which is known to the communication terminal.

A method for group communication between subscribers to different messaging services involves a first message, which has been sent by a second subscriber using a first messaging service, being received by a communication terminal of a first subscriber in a group communication session in which said communication terminal, said second subscriber and a third subscriber are participating. The communication terminal is used in the group communication session to send a second message, which contains a content from the received first message, to the third subscriber for reception using a second messaging service, which is different than the first messaging service.

A communication terminal has a reception device which is configured to receive a first message, which has been sent by a second subscriber using a first messaging service, in a group communication session in which the communication terminal, said second subscriber and a third subscriber are participating, and also has a transmission device which is configured to send a second message, which contains a content from the received first message, in the group communication session to the third subscriber for reception using a second messaging service, which is different than the first messaging service.

As a good example, one embodiment can be regarded as being that two subscribers in a group communication participate using different messaging services whose message transfer protocols are incompatible, and a communication terminal which is capable of communicating with both messaging services forwards a message from one subscriber, which has been sent using one messaging service, to the other subscriber, so that the latter can receive the message using the other messaging service.

This results in the advantage that group communication across messaging services is made possible. In this case, it is possible to use different messaging services whose message transfer protocols are incompatible. In particular, it becomes possible for messages sent within the group communication session by subscribers that are not themselves the group session initiator to reach the group members participating using other messaging services. Even if a subscriber is using a messaging service portal to communicate with subscribers to different messaging services, the subscribers to these messaging services can communicate in the group across messaging services.

It is also advantageous that the group communication does not require special matching to specific messaging service technologies. It is therefore also independent of possible technology changes in the messaging services used. Another advantage is that the messages from a subscriber to one messaging service to the subscribers to another messaging service do not have to be matched to the other messaging service by an entity in the communication network, for example by a bridge between the two messaging services.

In the various embodiments, where applicable, the explanations relating to the methods also apply mutatis mutandis to the apparatuses, and vice versa.

In line with one exemplary embodiment, the content of the received first message is a complete useful content from the received first message. As a good example, this means that the second message contains the complete information which the sender of the first message wanted to communicate. The content of the received first message, contained in what is known as the message body, is inserted completely into the second message which is to be sent.

In line with one exemplary embodiment, the method also includes the content of the received first message being copied using a computer application which is used by the communication terminal for communication using the first messaging service, and the second message being produced by means of another computer application which is used by the communication terminal for communication using the second messaging service, and the copied content being inserted into the second message. Expressed in the manner of a good example, if the communication terminal uses different applications for the communication using different messaging services, the content of the received message is copied from the received application and inserted into a new message produced by means of the sending application.

In this description, a computer application is intended to be understood to mean a program which is not necessarily executed on a computer, such as a personal computer (PC) or the like, but rather is executed on a communication terminal, for example, particularly by a processor in the communication terminal, for example. By way of example, a computer application can be executed by a baseband processor or an application processor in a mobile radio telephone.

In line with one exemplary embodiment, the method also includes the content of the received first message being copied, the second message being produced by means of a computer application which is used by the communication terminal for communication using the first messaging service and for communication using the second messaging service, and the copied content being inserted into the second message. Expressed in the manner of a good example, if the communication terminal uses a single application for communication using different messaging services, the content of the received message is copied and inserted into a new message produced by means of this application.

In line with one exemplary embodiment, the received first message is not formatted on the basis of a message transfer protocol from the second messaging service. Expressed in the manner of a good example, the first message has not been received by means of the second messaging service.

In line with one exemplary embodiment, the received first message is formatted on the basis of a message transfer protocol from the first messaging service. Expressed in the manner of a good example, the first message has been received by means of the first messaging service.

In line with one exemplary embodiment, the second message is not formatted on the basis of a message transfer protocol from the first messaging service. Expressed in the manner of a good example, the second message is not sent by means of the first messaging service.

In line with one exemplary embodiment, the second message is formatted on the basis of a message transfer protocol from the second messaging service. Expressed in the manner of a good example, the second message is sent by means of the second messaging service.

In line with one exemplary embodiment, the group communication session has one or more further subscribers and the second message is sent to those of the further subscribers which have not received the first message from the second subscriber. Expressed in the manner of a good example, the first message is forwarded in the form of the second message to those subscribers which have not received the first message directly from the sender. The communication terminal of the first subscriber can identify or ascertain those further subscribers to which the first message has been sent directly by the second subscriber, for example using the list of addressees for the first message. Provision may be made for a piece of information regarding those further subscribers to which the first message has been sent by the second subscriber to be contained in the first message.

In line with one exemplary embodiment, the group communication session has one or more further subscribers and the second message is sent to the further subscribers for reception using a respective messaging service which the respective further subscriber uses to receive messages in the group communication session.

In line with one exemplary embodiment, the first message has an identifier which identifies the first message as a group message from the group communication session. A group message is a message which a subscriber in the group communication session sends to a plurality of or all other subscribers in the group communication session.

In line with one exemplary embodiment, the second message has an identifier which identifies the second message as a group message from the group communication session. A group message is a message which a subscriber in the group communication session sends to a plurality of or all other subscribers in the group communication session.

In line with one exemplary embodiment, the second message has a sender specification, wherein the sender specification contains a subscriber address for the second subscriber. Expressed in the manner of a good example, this notifies a receiver of the second message that at least one portion of the content of the second message was originally sent by the second subscriber, which can be identified by its subscriber address. Expressed in the manner of a good example, the sender address entered for the forwarded message is the address of the original sender of the message.

In line with one exemplary embodiment, the first message is a response from the second subscriber to a group message from the group communication session which the second subscriber has received.

In line with one exemplary embodiment, the method also includes the received first message being identified as a group message from the group communication session or as a response to a group message from the group communication session. As a result, it becomes possible to forward only such contents as have been received as part of a group message or a group response. The identification can be made using information which characterizes the message, for example using a subject specification or using a specification which denotes the group communication session. Provision may also be made for the first message to be identified as a group message. Provision may also be made for the first message to be used to indicate all actual or all desired receivers in the content area, for example the message body, of the message. This makes it easier for the communication terminal to decide those subscribers to which the content of the first message needs to be forwarded using the second message. Provision may also be made for the actual or desired receivers to be indicated in the content of the second message. This ensures that the third subscriber receives this information when the second message is received.

In line with one exemplary embodiment, the group communication is effected by means of discrete messages, for example text messages. In line with another exemplary embodiment, the group communication is effected by means of continuous media, for example voice.

In line with one exemplary embodiment, the subscribers in the group communication session are indicated in the content of the first message or of the second message. It is possible to indicate the addresses or the names of the subscribers. In line with another exemplary embodiment, the sender of a message can be indicated in the content of the first message or of the second message, for example by indicating his subscriber address or his name.

In line with one exemplary embodiment, the content area of the first message or of the second message contains a group session indicator which indicates that the respective message has been sent as part of a group session. In line with another exemplary embodiment, the content area of the first message or of the second message contains a group session identifier which indicates that group session in which the respective message was sent.

In line with one exemplary embodiment, the first messaging service or the second messaging service is an instant messaging service. In an instant messaging service, the messages are sent to the receiver immediately. This means that the subscribers can communicate almost in real time. This type of service is therefore suitable for the rapid interchange of short messages and for participation in what is known as a conference chat (call group) with a plurality of subscribers. Examples of instant messaging services are “AOL Instant Messenger” (AIM) from the company AOL (“America Online”), “MSN Messenger” from the company MSN (“Microsoft Network Online Services”) and “Yahoo Instant Messenger” from the company Yahoo (“Yahoo! Inc.”).

In line with one exemplary embodiment, the first messaging service or the second messaging service is a store-and-forward service. In the case of this type of service, the interchanged messages are buffer-stored in a messaging service server and delivered to the receiver at a later time. Examples of store-and-forward services are e-mail (electronic mail) and the short messaging service SMS.

In line with one exemplary embodiment, the communication terminal communicates with the messaging services of the second subscriber and of the third subscriber using a messaging service portal. A messaging service portal allows standardized access to different messaging services. The communication terminal can use just one computer application to access the messaging service portal and hence indirectly to access different messaging services. An example of a messaging service portal is the “Full Messaging Portal” from the provider TJAT (TJAT Systems EU Limited, London, United Kingdom, www.tjat.com).

By way of example, a messaging service portal, for example the one from TJAT, can be reached from mobile radios using WAP. WAP stands for wireless application protocol, a method of internet access using mobile radios. However, a messaging service portal can also be accessed by means of other communication means and on other communication routes. In line with another exemplary embodiment, mobile radio access to a messaging service portal, for example the one from TJAT, is provided using the IP multimedia subsystem (Internet Protocol multimedia subsystem) IMS.

In line with one exemplary embodiment of the invention, a computer program product for group communication between subscribers to different messaging services is provided, wherein, when the computer program product is executed by a processor, a method according to one of the exemplary embodiments described in this application is carried out. The computer program product may contain a program code stored on a machine-readable medium. In line with another exemplary embodiment, a machine-readable medium is provided which stores a program code, wherein, when the program code is executed by a processor, a method according to one of the exemplary embodiments described in this application is carried out.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for group communication between subscribers to different messaging services, the method comprising:
receiving a first message, which has been sent by a second subscriber using a first messaging service, by means of a communication terminal of a first subscriber, in a group communication session in which the communication terminal of the first subscriber, a second subscriber and a third subscriber are participating; and
sending a second message, which contains a content from the received first message, by means of the communication terminal, in the group communication session, to the third subscriber for reception using a second messaging service, which is different than the first messaging service.

2. The method as claimed in claim 1,
wherein the content of the received first message is a complete useful content of the received first message.

3. The method as claimed in claim 1, further comprising:
copying the content of the received first message by means of a computer application which is used by the communication terminal for communication using the first messaging service;
producing the second message by means of another computer application which is used by the communication terminal for communication using the second messaging service; and
inserting the copied content into the second message.

4. The method as claimed in claim 1, further comprising:
copying the content of the received first message;
producing the second message by means of a computer application which is used by the communication terminal for communication using the first messaging service and for communication using the second messaging service; and
inserting the copied content into the second message.

5. The method as claimed in claim 1,
wherein the received first message is not formatted on the basis of a message transfer protocol of the second messaging service.

6. The method as claimed in claim 1,
wherein the received first message is formatted on the basis of a message transfer protocol of the first messaging service.

7. The method as claimed in claim 1,
wherein the second message is not formatted on the basis of a message transfer protocol of the first messaging service.

8. The method as claimed in claim 1,
wherein the second message is formatted on the basis of a message transfer protocol of the second messaging service.

9. The method as claimed in claim 1,
wherein the group communication session has one or more further subscribers and
wherein the second message is sent to those of the further subscribers which have not received the first message from the second subscriber.

10. The method as claimed in claim 1,
wherein the group communication session has one or more further subscribers and
wherein the second message is sent to the further subscribers for reception using a respective messaging service which the respective further subscriber uses to receive messages in the group communication session.

11. The method as claimed in claim 1,
wherein the second message has an identifier which identifies the second message as a group message from the group communication session.

12. The method as claimed in claim 1,
wherein the second message has a sender specification, and wherein the sender specification contains a subscriber address of the second subscriber.

13. The method as claimed in claim 1,
wherein the first message has an identifier which identifies the first message as a group message from the group communication session.

14. The method as claimed in claim 1,
wherein the first message is a response from the second subscriber to a group message from the group communication session which the second subscriber has received.

15. The method as claimed in claim 1, further comprising:
identifying the received first message as a group message from the group communication session or as a response to a group message from the group communication session.

16. A communication terminal, comprising:
a reception device, configured to receive a first message, which has been sent by a second subscriber using a first messaging service, in a group communication session in which the communication terminal, a second subscriber and a third subscriber are participating; and
a transmission device, configured to send a second message, which contains a content from the received first message, in the group communication session, to the third subscriber for reception using a second messaging service, which is different than the first messaging service.

17. The communication terminal as claimed in claim 16, further comprising:
a computer application which is used by the communication terminal for communication using the first messaging service; and
another computer application, which is used by the communication terminal for communication using the second messaging service and which is configured to produce the second message; and wherein the communication terminal is configured to copy the content of the received first message using the computer application and to insert the copied content into the second message.

18. The communication terminal as claimed in claim 16, further comprising:
a computer application which is used by the communication terminal for communication using the first messaging service and for communication using the second messaging service and which is configured to produce the second message; and
wherein the communication terminal is configured to copy the content of the received first message and to insert the copied content into the second message.

19. The communication terminal as claimed in claim 16,
wherein the group communication session has one or more further subscribers and
wherein the communication terminal is configured to ascertain those of the further subscribers which have not received the first message from the second subscriber and is configured to send the second message to the ascertained further subscribers.

20. The communication terminal as claimed in claim 16,
wherein the group communication session has one or more further subscribers and
wherein the communication terminal is configured to send the second message to the further subscribers for reception using a respective messaging service which the respective further subscriber uses to receive messages in the group communication session.

21. The communication terminal as claimed in claim 16,
wherein the communication terminal is configured to receive an identifier for the first message which identifies the first message as a group message from the group communication session.

22. The communication terminal as claimed in claim 16,
wherein the communication terminal is configured to send the second message with an identifier which identifies the second message as a group message from the group communication session.

23. The communication terminal as claimed in claim 16,
wherein the communication terminal is configured to send the second message with a sender specification, and wherein the sender specification contains a subscriber address for the second subscriber.

24. The communication terminal as claimed in claim 16, further comprising:
an identification device configured to identify the received first message as a group message from the group communication session or as a response to a group message from the group communication session.

25. A computer program product for group communication between subscribers to different messaging services, wherein, when the computer program product is executed by a processor, a method for group communication between subscribers to different messaging services is carried out, the method comprising:
receiving a first message, which has been sent by a second subscriber using a first messaging service, by means of a communication terminal of a first subscriber, in a group communication session in which the communication terminal of the first subscriber, a second subscriber and a third subscriber are participating; and
sending a second message, which contains a content from the received first message, by means of the communication terminal, in the group communication session, to the third subscriber for reception using a second messaging service, which is different than the first messaging service.
